(19) United States
(12) Patent Application Publication
(10) Pub. No.: US 2015/0185871 A1
(43) Pub. Date: Jul. 2, 2015

(54) GESTURE PROCESSING APPARATUS AND METHOD FOR CONTINUOUS VALUE INPUT

(71) Applicant: Electronics and Telecommunications Research Institute, Daejeon (KR)

(72) Inventors: Hyuk JEONG, Daejeon (KR); Ji Young PARK, Daejeon (KR); Kwang Hyun SHIM, Daejeon (KR); Ju Yong CHANG, Daejeon (KR); Hee Kwon KIM, Daejeon (KR); Moon Wook RYU, Seoul (KR); Soon Chan PARK, Daejeon (KR); Seung Woo NAM, Daejeon (KR)

(21) Appl. No.: 14/335,854

(22) Filed: Jul. 18, 2014

(30) Foreign Application Priority Data
Jan. 2, 2014 (KR) 10-2014-0000182

(51) Int. Cl. G06F 3/038; G06F 3/0488; G06F 3/0481; G06F 3/0354; G06F 3/01

(52) U.S. Cl. CPC G06F 3/038; G06F 3/03543; G06F 3/03547; G06F 3/017; G06F 3/04812; G06F 3/04883

(57) ABSTRACT

Provided is a gesture processing method for continuous value input. The gesture processing method includes acquiring a gesture input, extracting a moving direction of a pointing means interoperating with the gesture input, extracting a direction change angle of the pointing means, when the pointing means is moved after the moving direction and the direction change angle are extracted, extracting a relative position indicating a continuous movement amount of the pointing means, matching the extracted relative position with a continuous value of a control item, combining the moving direction of the pointing means, the direction change angle of the pointing means, and the relative position to control setting of the control item, and executing a control instruction for the control item.

### CROSS-REFERENCE TO RELATED APPLICATIONS

This application claims priority under 35 U.S.C. §119 to Korean Patent Application No. 10-2014-0000182, filed on Jan. 2, 2014, the disclosure of which is incorporated herein by reference in its entirety.

### TECHNICAL FIELD

The present invention relates a gesture processing apparatus and method for continuous value input, and more particularly, to a gesture-based input device and method for controlling various factors having continuous values.

### BACKGROUND

When computers, mobile devices, and so on are used, a pointing input such as a mouse and a human finger is needed to select a specific menu in a graphic user interface (GUI) environment. In addition, this pointing input is required to execute an instruction associated with an icon or menu that is pointed by a pointer of the pointing input by clicking a button.

This pointing input may control a computer or mobile device in other manners, one of which is a mouse gesture.

The mouse gesture makes use of a motion of a pointer, not an accurate position of the pointer. That is, if the mouse pointer is moved to a specific position while a right button of the mouse is clicked, mouse gesture software in a system recognizes a motion of the pointer and perform a predefined instruction (for example, viewing of a previous page, viewing of a next page, turning up of volume, turning down of volume, and so on).

The related art relates to a user interface using a one-hand gesture on a touch pad (Korean Patent No. 10-1154137) and provides a touch user interface device and method for performing direct control by a one-finger gesture, which include awaiting a second touch input detected next to a menu entry gesture when a first touch input detected on a touch pad is determined as the menu entry gesture, determining at least one selection function among selection functions according to a position where the menu entry gesture is made, a start point of the second touch input, a direction of the second touch input, and a combination thereof, deciding a detailed control gesture on the basis of a third touch input in a clockwise or counter-clockwise direction or in an up-and-down or left-and-right direction from a position where the selection function is determined, with respect to the determined selection function and deciding whether the first touch input is the menu entry gesture based on the gesture pattern, and if the touch input is determined as the menu entry gesture, recognizing the second touch input prior to recognizing a pointing or selection for a position corresponding to a coordinate where the first touch input is detected.

However, in the related art, there is a limitation in that only one of single instruction execution and continuous value input is allowed.

### SUMMARY

Accordingly, the present invention provides a gesture processing apparatus and method that may perform execution of a single instruction and input of a continuous value in one process according to a range of a direction change angle.

In one general aspect, a gesture processing apparatus for continuous value input, the gesture processing apparatus includes: an input unit configured to acquire a gesture input; a moving direction extraction unit configured to extract a moving direction of a pointing means interoperating with the gesture input; a direction change extraction unit configured to extract a direction change angle of the pointing means; a relative-position extraction unit configured to, when the pointing means is moved after the moving direction and the direction change angle are extracted, extract a relative position indicating a continuous movement amount of the pointing means; a control unit configured to combine the moving direction of the pointing means, the direction change angle of the pointing means, and the relative position in response to the acquired gesture input to execute a control instruction for controlling an output of the control item; and a display unit configured to display the control item according to the control instruction.

In another general aspect, a gesture processing method for continuous value input, the gesture processing method includes: acquiring a gesture input; extracting a moving direction of a pointing means interoperating with the gesture input; extracting a direction change angle of the pointing means; when the pointing means is moved after the moving direction and the direction change angle are extracted, extracting a relative position indicating a continuous movement amount of the pointing means; matching the extracted relative position with a continuous value of a control item; combining the moving direction of the pointing means, the direction change angle of the pointing means, and the relative position to control setting of the control item; and executing a control instruction for the control item.

In still another aspect, a gesture processing apparatus for continuous value input, the gesture processing apparatus includes: a moving direction extraction unit configured to extract a moving direction of a human body portion; a direction change extraction unit configured to extract a direction change angle of the human body portion; a relative-position extraction unit configured to, when the human body portion is moved after the moving direction and the direction change angle are extracted, extract a relative position indicating a continuous movement amount of the human body portion; a control unit configured to combine the moving direction of the human body portion, the direction change angle of the human body portion, and the relative position to execute a control instruction for controlling an output of a control item; and a display unit configured to display the control item according to the control instruction.

Other features and aspects will be apparent from the following detailed description, the drawings, and the claims.

### BRIEF DESCRIPTION OF THE DRAWINGS

FIG. 1 is a block diagram showing a gesture processing apparatus for continuous value input according to an embodiment of the present invention.

FIG. 2 is a flowchart showing a gesture processing method for continuous value input according to an embodiment of the present invention.

FIG. 3 is a view showing a case in which a direction of a pointing means is not changed according to an embodiment of the present invention.

FIG. 4 is a view showing a case in which a direction of a pointing means is changed (by 180 degrees) according to an embodiment of the present invention.

FIG. 5 is a view showing a case in which a direction of a pointing means is changed (by 90 degrees) according to an embodiment of the present invention.

FIG. 6 is a view showing a case in which a direction of a pointing means is changed (by 90 degrees) according to an embodiment of the present invention.

FIG. 7 is a view showing a view illustrating a configuration of a computer device in which a gesture processing method for continuous value input according to an embodiment of the present invention is executed.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, specific embodiments will be described in detail with reference to the accompanying drawings.

Functions performed through a gesture are largely classified into two groups: one is a function of performing one instruction such as “copy” and “open,” and the other is a function of controlling a certain continuous value, for example, a volume, a video relay timing, and a screen brightness. In the single instruction execution method, a system recognizes a specific pattern to execute an instruction according to a predetermined rule when a gesture input is completed.

Meanwhile, in the continuous value input method, a system measures a size or distance of a specific pattern to input a certain value based on the size or distance.

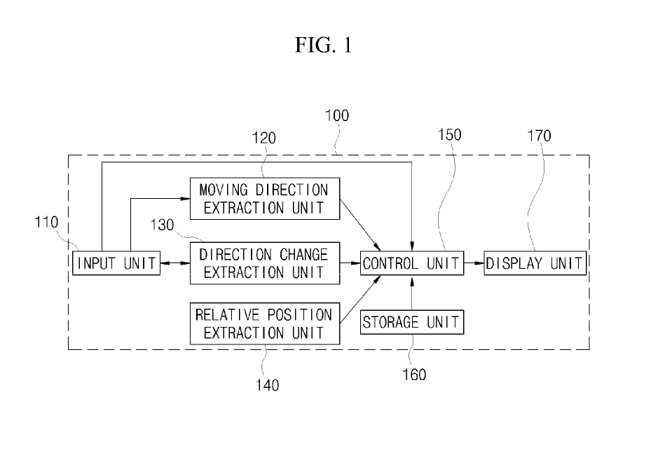

FIG. 1 is a block diagram showing a gesture processing apparatus for continuous value input according to an embodiment of the present invention.

As shown in FIG. 1, a gesture processing apparatus 100 for continuous value input includes an input unit 110, a moving direction extraction unit 120, a direction change extraction unit 130, a relative position extraction unit 140, a control unit 150, a storage unit 160, and a display unit 170.

Here, the pointing means includes a mouse pointer, a touch screen input of a user, and so on.

The input unit 110 acquires a gesture input from a user. The gesture input may be set to be started when a specific button of a mouse is pressed by a user or a user's finger is in contact with an input device such as a touch input screen.

The moving direction extraction unit 120 extracts a moving direction of a pointing means interoperating with the gesture input. When a user moves a mouse pointer after pressing the specific button of the mouse pointer, the moving direction extraction unit 120 calculates and extracts the moving direction of the pointer. In this case, the moving direction of the pointer is referred to as “a.”

The direction change extraction unit 130 extracts a direction change angle of the pointing means. If a user moves a mouse pointer in one direction and then change the direction, the direction change extraction unit 130 extracts an angle between a segment of a previous moving direction and a segment of a new moving direction, that is, a direction change angle of a mouse pointer.

The relative position extraction unit 140 extracts a relative position of the pointing means. Specifically, if the pointing means is moved after a moving direction and angle is extracted, the relative position extraction unit 140 extracts a relative position indicating a continuous movement amount of the pointing means.

In response to the acquired gesture input, the control unit 150 combines a direction change angle and a relative position of the pointing means with the moving direction of the pointing means to execute a control instruction for controlling an output of the control item.

The control unit 150 matches the extracted relative position with a continuous value of the control item, controls setting of the control item on the basis of a continuous movement amount of the pointing means, and then executes the control instruction of the control item.

The control unit 150 executes the control instruction and generates a gesture completion signal. Here, the gesture completion signal means that a mouse button state is changed through a user's input, or a user touch screen input is released on a touch input screen.

The control unit 150 controls at least one of a sound volume, a screen brightness, a screen sharpness, and a screen size when controlling the setting of the control item.

The storage unit 160 stores at least one of the moving direction of the pointing means, the direction change angle of the pointing means, and the control item.

The control unit 150 generates a gesture processing pattern of a user if the number of times using the at least one of the moving direction of the pointing means, the direction change angle of the pointing means, and the control item stored in the storage unit 160 is greater than a predetermined threshold value.

If the generated gesture processing pattern is in a predetermine error range, the control unit 150 determines the gesture processing pattern as normal to execute the control instruction on the basis of the gesture processing pattern.

The control unit 150 allows the control item to be controllable by displaying a different continuous-valued parameter on the display unit 170.

The display unit 170 displays at least one of the pointing means and the control item according to a control instruction.

According to an embodiment of the present invention, “b” is a direction change value, which is based on the direction change angle. The direction change value “b” is determined as follows: 1) in a case of no direction change, b=0; 2) in a case of 180 degree direction change (the moving direction is changed to a direction opposite to an initial moving direction), b=2; and 3) in a case of 90 degree direction change (the moving direction is changed by 90 degree to a right or left direction), b=1.

In a case of b=0 (0 degree direction change), the moving direction extraction unit 120 only continuously calculate and extract a pointer moving direction before the gesture completion signal is received. When the gesture completion signal is received during this process (for example, when the user presses a specific button of a mouse again or release his/her finger from the touch input device), the control unit 150 generates a gesture completion signal.

In this case, “a” is a moving direction of a pointer. The control unit 150 performs a single instruction according to “a.” For example, the moving direction of the pointer is divided into four: “a” may be set to be 0 for a right direction, 1 for an up direction, 2 for a left direction, and 3 for a down direction. The control unit 150 may be set to perform four different instructions according to a moving direction of a pointer.

When b=2 (180 degree direction change), the control unit 150 may be set to perform different instructions according to “a.” In this case, when “a” has four states, that is, up, down, left, and right, the control unit 150 may be set to perform four instructions.

When b=1 (90 degree direction change), the display unit 170 receives a control instruction from the control unit 150 and displays a different continuous-valued parameter on a screen according to “a” to allow the control item to be controllable.

If the control item is displayed on the screen and the pointer is continuously moved after the direction change, the relative position extraction unit 140 calculates and extracts a value of a relative position from a point where the direction change is made to the changed direction. Here, the relative position refers to a continuous movement amount of the pointer.

In this case, “c” is a relative position value, which is reflected as continuous value to the relative position extraction unit 140 and also the system. Before the gesture completion signal is received, this process is repeated and the continuous value is set.

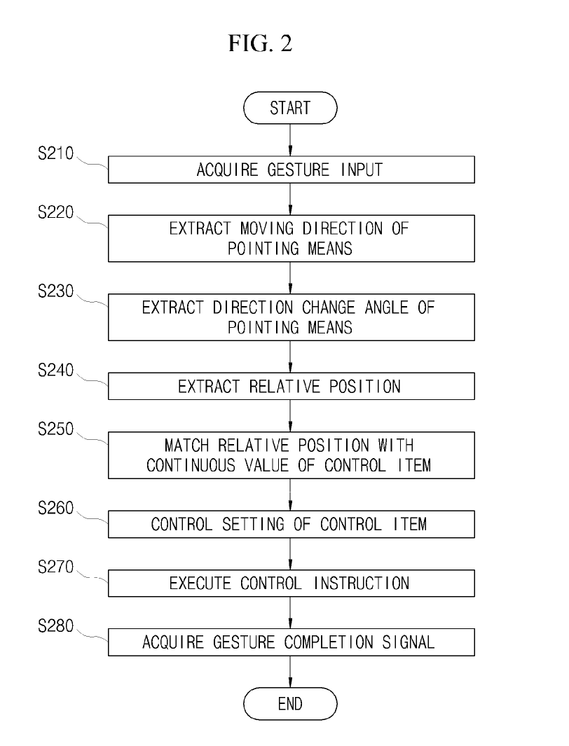

FIG. 2 is a flowchart showing a gesture processing method for continuous value input according to an embodiment of the present invention.

As shown in FIG. 2, first, the method acquires a gesture input in step S210. Specifically, the input unit 110 acquires a gesture input (for example, a mouse pointer input or touch screen input) from a user.

The moving direction extraction unit 120 extracts a moving direction of a pointing means that is displayed on a screen in response to the acquired gesture input in step S220. Here, the pointing means includes a mouse pointer or a touch screen input of a user, which is displayed on a screen.

The direction change extraction unit 130 extracts a direction change angle of the pointing means in step S230. Specifically, the direction change extraction unit 130 extracts a direction change angle by measuring an angle that varies depending on the moving direction of the pointer.

Here, “b” is a direction change value, which is based on the direction change angle. The direction change value “b” is determined as follows: 1) in a case of no direction change, b=0; 2) in a caser of 180 degree direction change (the moving direction is changed to a direction opposite to an initial moving direction), b=2; and 3) in a case of 90 degree direction change (the moving direction is changed by 90 degree to a right or left direction), b=1.

The control unit 150 outputs a corresponding control item to the screen on the basis of the extracted direction change angle and the direction change value.

For example, if the user changes the direction by 90 degrees in a right direction with respect to an initial moving direction during execution of a music replay program, the control unit 150 outputs a control item for controlling a volume to a screen.

In addition, if the user changes the direction by 90 degrees in a left direction with respect to an initial moving direction during execution of a music replay program, the control unit 150 outputs a control item for controlling a video replay timing to a screen.

The relative position extraction unit 140 extracts a relative position of the continuous movement amount of the pointing means in step S240.

The control unit 150 matches the extracted relative position with the continuous value of the control item in step S250. When the control item is a volume control window, the control unit 150 matches the relative position, which is a continuous movement amount of the pointing means, with a continuous value of the volume control window.

The control unit 150 controls setting of the control item by combining the moving direction of the pointing means, the direction change angle of the pointing means, and the relative position in step S260.

Specifically, the control unit 150 controls setting of the control item by displaying a different continuous-valued parameter on a screen (for example, the display unit 170) depending on the moving direction of the pointing means.

For example, in a case in which a volume control item having initial volume set to be 30% is displayed, if the pointer is moved upward, the volume is turned up (for example, volume: 50%) corresponding to the movement amount, that is, the relative position of the pointer, and if the pointer is moved downward, the volume is turned down (for example, volume: 20%) corresponding to the movement amount.

The control unit 150 executes the control instruction for the control item in step S270. Specifically, the control unit 150 executes the control instruction for the volume control item.

The control unit 150 ends the execution when the gesture completion signal is acquired in step S280. For example, if a mouse button state is changed through a user's input, or a user touch screen input is released on a touch input screen, the control unit 150 ends the control instruction execution of the volume control item.

According to another embodiment of the present invention, it is possible to remember a gesture processing pattern of a user to recognize a user's intention and execute a control instruction associated with the user's intention even when the user performs a behavior having a few errors within an error range.

The storage unit 160 stores at least one of the moving direction of the pointer, the direction change angle of the pointer, and the control item.

For example, if a user moves the mouse pointer in a right direction and then in a down direction of 90 degrees while a music relay program is executed, a volume control item is displayed. The user controls volume through the mouse pointer.

The control unit 150 generates a gesture processing pattern of a user if the number of times using the at least one of the moving direction of the pointing means, the direction change angle of the pointing means, and the control item stored in the storage unit 160 is greater than a predetermined threshold value.

For example, if the number of times a user controls the volume control item using the mouse pointer in the music replay program is greater than five, the control unit 150 generates a gesture processing pattern of the user.

If the generated gesture processing pattern is in a predetermine error range, the control unit 150 determines the gesture processing pattern as normal to execute the control instruction on the basis of the gesture processing pattern.

For example, if a user moves the mouse pointer in a down direction of 70 to 110 degrees, not in a down direction of 90 degrees after moving the mouse pointer in a right direction, the control unit 150 remembers the gesture processing pattern during a certain time of period of a user stored in the storage unit 160, determines that the user intends to control the volume control item, and executes a volume control instruction.

—Case of Recognizing Specific Motion without Pointer—

As another example of the present invention, the present invention may be implemented to perform control using a pointing means such as a human body portion, other than the mouse pointer. For example, if a user raises his/her hand, makes a fist, moves the first rightward and then upward by 90 degrees in front of a screen of a table PC while replaying a video, the volume control item may be displayed, and the user may control the volume by moving the first upward and downward.

For example, if the user moves his/her first rightward and then upward by 90 degrees, the control unit 150 outputs a control item for controlling a replay timing. Accordingly, the user may control the replay timing by moving his/her first leftward and rightward. In addition, when the user opens his/her fist, the gesture completion signal is applied, and the replay timing control is completed.

A gesture processing apparatus 100 for continuous value input, which implements the above-description, includes a moving direction extraction unit 120, a direction change extraction unit 130, a relative position extraction unit 140, a control unit 150, a storage unit 160, and a display unit 170.

The moving direction extraction unit 120 extracts a shape and a moving direction of a human body portion. The moving direction extraction unit 120 includes a function of sensing a motion of the human body portion. If a user makes a first and moves the first rightward, the moving direction extraction unit 120 extracts the shape of the hand as a first and the moving direction of the first as right.

The direction change extraction unit 130 extracts a direction change angle of the human body portion.

The relative position extraction unit 140 extracts a relative position indicating a continuous movement amount of the human body portion. Here, the human body portion includes a pointing means such as a first or finger.

The control unit 150 combines a shape of the human body portion, a moving direction of the human body portion, a direction change angle of the human body portion, and a control item to execute a control instruction for controlling an output of the control item.

If it is determined that the shape of the human body portion extracted from the mobile direction extraction unit 120 is changed, the control unit 150 generates a gesture completion signal and ends the execution of the control instruction. For example, the change of the shape of the human body portion includes opening or closing the hand or finger of the user.

If the degree of change in shape of the human body portion as a result of comparison an initial shape of the human body portion with a later shape of the human body portion is greater than a predetermined threshold value, the control unit 150 generates a gesture completion signal and ends the execution of the control instruction.

That is, the user closes the hand when the user input a gesture while the user opens the hand when the user applies the gesture completion signal.

The storage unit 160 stores at least one of the shape of the human body portion, the moving direction of the human body portion, the direction change angle of the human body portion, and the control item.

The display unit 170 displays the control item according to the control instruction.

Here, of course, the pointing means may be a separate pointing means such as an indicator and a stylus, other than the human body portion, for example a first or finger.

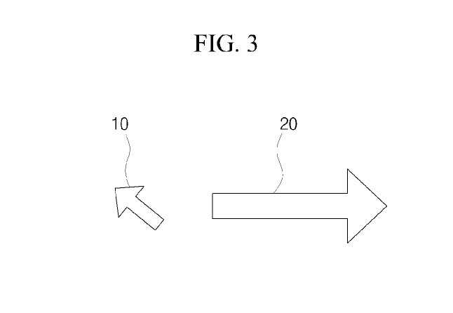

FIG. 3 is a view showing a case in which a direction of a pointing means is not changed according to an embodiment of the present invention.

As shown in FIG. 3, if the direction of the pointing means 10 is not changed (an arrow 20 keeps the right direction and doesn't turn down or up), and the pointing means (for example, a mouse pointer or touch screen input) is moved rightward, a video replay program is executed depending on “a” which is a predetermined moving direction of the pointing means. When a=0 (rightward), a video after one minute is replayed.

When a=1 (leftward), a video before one minute is replayed, and when a=2 (upward), the volume is turned up. When a=3 (downward), the volume is turned down.

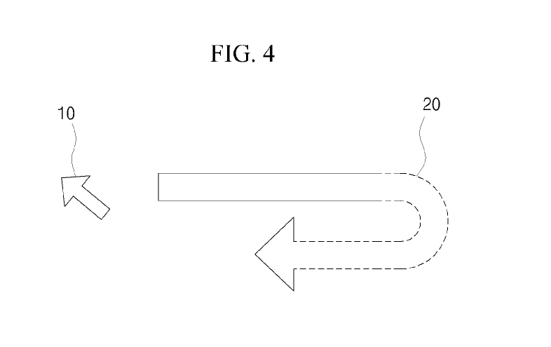

FIG. 4 is a view showing a case in which a direction of a pointing means is changed (by 180 degrees) according to an embodiment of the present invention.

As shown in FIG. 4, if the direction of the pointing means 10 is changed by 180 degrees (an arrow 20 moves rightward and turns to the left direction), and the pointing means (for example, a touch screen input) is finally moved rightward, a video replay program is executed depending on “a,” which is a final moving direction of the pointing means. When a=0, a video after one minute is replayed.

When a=1 (leftward), a video before one minute is replayed, and when a=2 (upward), the volume is turned up. When a=3 (downward), the volume is turned down.

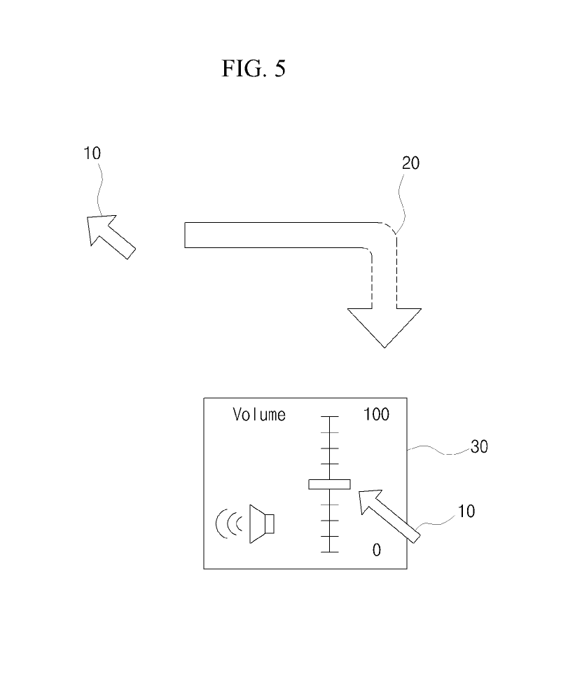

FIG. 5 is a view showing a case in which a direction of a pointing means is changed (by 90 degrees) according to an embodiment of the present invention.

As shown in FIG. 5, if the pointing means 10 is moved right by a certain distance and then turned (an arrow 20 indicating to turn down by 90 degrees), a control item 30 for controlling volume is displayed during execution of a video program. Accordingly, the user may control setting of the volume control item based on a motion of the pointing means 10.

Accordingly, the execution of the specific instruction (for example, the display of the volume control item) and the input of the continuous value (for example, the control of the volume) may be performed in one process.

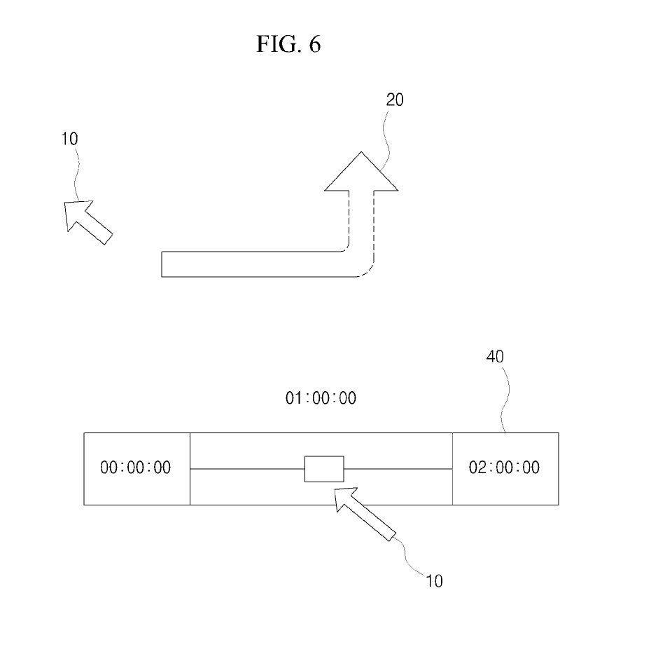

FIG. 6 is a view showing a case in which a pointing means is turned (by 90 degrees) according to an embodiment of the present invention.

As shown in FIG. 6, if the pointing means 10 is moved right by a certain distance and then turned (an arrow 20 indicating to turn up by 90 degrees), a control item 40 for controlling a replay timing is displayed during execution of a video program. Accordingly, the user may control setting of the replay timing control item based on a motion of the pointing means 10.

In particular, the execution of the specific instruction (for example, the display of the replay timing control item) and the input of the continuous value (for example, the control of the replay timing) may be performed in one process.

According to the present invention, it is possible to perform execution of a single instruction and input of a continuous value simultaneously in a gesture of moving a point means and perform execution of a single instruction and input of a continuous value in one process through a simple gesture, without exposure of a menu or icon on a screen while a user has a focus on content (for example, a movie, a music, and so on), thereby enhancing user convenience.

In particular, for a person who have difficulties in selecting an icon at a specific position on a touch screen, for example, a blind person, it is possible to conveniently use a mobile device including a touch screen input function with a simple gesture, thereby enhancing user convenience.

It is also possible to generate a gesture processing pattern based on a moving direction of a pointing means, a direction change angle of a pointing means, and a control item and recognize a user's intention to execute a control instruction if the gesture processing pattern is in a certain error range even when the gesture processing pattern has a few errors, thereby enhancing user convenience.

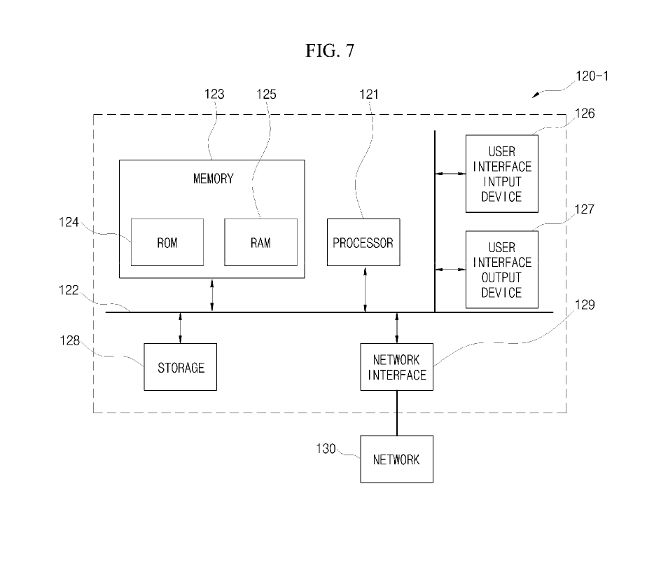

A gesture processing method for continuous value input according to an embodiment of the present invention may be implemented in a computer system, e.g., as a computer readable medium. As shown in in FIG. 7, a computer system 120-1 may include one or more of a processor 121, a memory 123, a user input device 126, a user output device 127, and a storage 128, each of which communicates through a bus 122. The computer system 120-1 may also include a network interface 129 that is coupled to a network 130. The processor 121 may be a central processing unit (CPU) or a semiconductor device that executes processing instructions stored in the memory 123 and/or the storage 128. The memory 123 and the storage 128 may include various forms of volatile or non-volatile storage media. For example, the memory may include a read-only memory (ROM) 124 and a random access memory (RAM) 125.

Accordingly, a gesture processing method for continuous value input according to an embodiment of the present invention may be implemented as a computer implemented method or as a non-transitory computer readable medium with computer executable instructions stored thereon. In an embodiment, when executed by the processor, the computer readable instructions may perform a method according to at least one aspect of the invention.

The spirit of the present invention has been just exemplified. It will be appreciated by those skilled in the art that various modifications and alterations can be made without departing from the essential characteristics of the present invention. Accordingly, the embodiments disclosed in the present invention and the accompanying drawings are used not to limit but to describe the spirit of the present invention. The scope of the present invention is not limited only to the embodiments and the accompanying drawings. The protection scope of the present invention must be analyzed by the appended claims and it should be analyzed that all spirits within a scope equivalent thereto are included in the appended claims of the present invention.

What is claimed is:

1. A gesture processing apparatus for continuous value input, the gesture processing apparatus comprising:
an input unit configured to acquire a gesture input;
a moving direction extraction unit configured to extract a moving direction of a pointing means interoperating with the gesture input;
a direction change extraction unit configured to extract a direction change angle of the pointing means;
a relative-position extraction unit configured to, when the pointing means is moved after the moving direction and the direction change angle are extracted, extract a relative position indicating a continuous movement amount of the pointing means;
a control unit configured to combine the moving direction of the pointing means, the direction change angle of the pointing means, and the relative position in response to the acquired gesture input to execute a control instruction for controlling an output of the control item; and
a display unit configured to display at least one of the pointing means and the control item according to the control instruction.

2. The gesture processing apparatus of claim 1, wherein the control unit matches the extracted relative position with the continuous value of the control item, controls setting of the control item based on a motion of the pointing means, and then executes the control instruction of the control item.

3. The gesture processing apparatus of claim 1, wherein the control unit executes the control instruction and generates a gesture completion signal.

4. The gesture processing apparatus of claim 3, wherein the gesture completion signal means that a mouse button state is changed through a user's input, or a user touch screen input is released on a touch input screen.

5. The gesture processing apparatus of claim 1, wherein the control unit controls at least one of a sound volume, a screen brightness, a screen sharpness, and a screen size when controlling setting of the control item.

6. The gesture processing apparatus of claim 1, further comprising a storage unit configured to store at least one of the moving direction of the pointing means, the direction change angle of the pointing means, and the control item.

7. The gesture processing apparatus of claim 5, wherein,
when the number of times using the at least one of the moving direction of the pointing means, the direction change angle of the pointing means, and the control item stored in the storage unit is greater than a predetermined threshold value, the control unit generates a gesture processing pattern of a user, and
when the generated gesture processing pattern is in a certain error range, the control unit determines the generated gesture processing pattern as normal to execute the control instruction based on the gesture processing pattern.

8. The gesture processing apparatus of claim 1, wherein the control unit displays a different continuous-valued parameter depending on the moving direction of the pointing means to allow the control item to be controllable.

9. A gesture processing method for continuous value input, the gesture processing method comprising:
acquiring a gesture input;
extracting a moving direction of a pointing means interoperating with the gesture input;
extracting a direction change angle of the pointing means;
when the pointing means is moved after the moving direction and the direction change angle are extracted, extracting a relative position indicating a continuous movement amount of the pointing means;
matching the extracted relative position with a continuous value of a control item;
combining the moving direction of the pointing means, the direction change angle of the pointing means, and the relative position to control setting of the control item; and
executing a control instruction for the control item.

10. The gesture processing method of claim 9, further comprising, when a gesture completion signal is acquired after the control instruction of the control item is output, ending the execution.

11. The gesture processing method of claim 9, wherein the acquiring of a gesture input is performed through a mouse pointer input or touch screen input.

12. The gesture processing method of claim 9, further comprising: after controlling of setting of the control item,
storing at least one of the moving direction of the pointing means, the direction change angle of the pointing means, and the control item;
when the number of times using the at least one of the moving direction of the pointing means, the direction change angle of the pointing means, and the control item stored in the storage unit is greater than a predetermined threshold value, generating a gesture processing pattern of a user; and
when the generated gesture processing pattern is in a certain error range, determining the generated gesture processing pattern as normal to execute the control instruction based on the gesture processing pattern.

13. The gesture processing method of claim 9, wherein the controlling of setting of the control item is performed by displaying a different continuous-valued parameter on a screen depending on the moving direction of the pointing means.

14. A gesture processing apparatus for continuous value input, the gesture processing apparatus comprising:
a moving direction extraction unit configured to extract a shape and a moving direction of a human body portion;
a direction change extraction unit configured to extract a direction change angle of the human body portion;
a relative-position extraction unit configured to, when the human body portion is moved after the moving direction and the direction change angle are extracted, extract a relative position indicating a continuous movement amount of the human body portion;
a control unit configured to combine the shape of the human body portion, the moving direction of the human body portion, the direction change angle of the human body portion, and the relative position to execute a control instruction for controlling an output of a control item; and
a display unit configured to display the control item according to the control instruction.

15. The gesture processing apparatus of claim 14, wherein the control unit generates a gesture completion signal when it is determined that the shape of the human body portion is changed.
